(19) United States
(12) Patent Application Publication
(10) Pub. No.: US 2007/0249266 A1
(43) Pub. Date: Oct. 25, 2007

(54) Manufacturing method of solid-state imaging device

(75) Inventor: Toru Hachiya, Kurokawa-gun (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/785,685

(22) Filed: Apr. 19, 2007

(30) Foreign Application Priority Data
Apr. 21, 2006 (JP) P2006-117940

(51) Int. Cl. B24B 1/00; C04B 35/64

(52) U.S. Cl. 451/28; 264/603

(57) ABSTRACT

A method for forming an organic film is provided and includes: forming an insulation film above a substrate; performing a sintering before or after the forming of the insulation film; forming an organic film on the insulation film; and then removing, by polish, a charged layer in a surface of the organic film.

### BACKGROUND OF THE INVENTION

1. Field of the Invention

The present invention relates to a manufacturing method of a solid-state imaging device, and more particularly to a manufacturing method of a solid-state imaging device, which can prevent charge transfer efficiency from deteriorating resulting from the unwanted charges occurred on the surface of an organic insulation film of the color filter, etc. thereof.

2. Description of Related Art

The solid-state imaging devices, of MOS and CCD types, each have a substrate, a photoelectric converter, such as photodiodes, formed on the substrate, and a charge transferer for transferring the charge generated at the photoelectric converter. Meanwhile, a light-shielding film is formed above the charge transfer electrodes constituting the charge transferer. Over the light-shielding film, there are formed a planarization film of BPSG (borophospho silicate glass), an insulation film of P-SiN (so-called a passivation film), and a lower planarization film of transparent resin or the like. A color filter is formed of an organic insulation material in a level upper than the lower planarization film, above which a microlens layer is formed through an upper planarization film.

Before or after forming of a passivation film, a thermal process (hereinafter, referred to as sintering) is performed in an atmosphere of inert gas and H₂. This achieves dangling-bond termination and unwanted-charge removal. The dangling-bond termination can improve the characteristics in dark unique to the CCD while unwanted-charge removal improves charge transfer efficiency. It is a practice to form a microlens above the color filter by spin-coating an organic insulation material for a color filter after sintering and then forming a color pattern corresponding to the photodiodes formed on the substrate (see JP-A-9-172153, JP-A-9-172154, JP-A-2006-319133 and JP-A-2006-351786, for example).

In the meanwhile, the organic insulation material of a color filter of the solid-state imaging device, there encounters a phenomenon that static electricity remains on the film surface of the organic insulation material due to the repeated processing of pure-water rinsing and high-speed spin drying on each layer. Meanwhile, the organic insulation material of a color filter, etc. is low in thermal resistance and hence, once formed, is not to be removed of electricity by sintering. This results in the state that static electricity remains on the organic insulation material. Thus there is a room to improve it in respect of the cause to lower the efficiency of charge transfer upon an imaging operation.

### SUMMARY OF THE INVENTION

An object of an illustrative, non-limiting embodiment of the invention is to provide a manufacturing method for a solid-state imaging device, which can prevent charge transfer efficiency from lowering due to the electric charge existing on the surface of an organic insulation material of the color filter, etc. thereof.

The object can be achieved by the following.
(1) A method for forming an organic film, comprising: forming an insulation film above a substrate; performing a sintering before or after the forming of the insulation film; forming an organic film on the insulation film; and removing, by polish, a charged layer in a surface of the organic film.
(2) A method for manufacturing a solid-state imaging device, comprising: forming an insulation film above a substrate for the solid-state imaging device; sintering the insulation film; forming a color filter layer on the insulation film; and removing, by polish, a charged layer in a surface of the color filter layer.
(3) The method for manufacturing a solid-state imaging device according to (2), wherein the charged layer is polished by a chemical mechanical polishing process.
(4) The method for manufacturing a solid-state imaging device according to (2) or (3), wherein the polish is performed by abrasive-free polishing with a conductive solution comprising a surface-active agent or a hydrophilic surface-treatment agent equivalent thereto.
(5) The method for manufacturing a solid-state imaging device according to any one of (2) to (4), wherein the color filter layer has a plurality of color filters, and a layer lowest in polish rate of the plurality of color filters is taken as a polish stopper layer.

### BRIEF DESCRIPTION OF THE DRAWINGS

The features of the invention will appear more fully upon consideration of the exemplary embodiments of the inventions, which are schematically set forth in the drawings, in which:

FIG. 1 is a plan view of a solid-state imaging device;

FIG. 2 is a sectional view on line A-A in FIG. 1;

FIG. 3 is a sectional view showing a state in which a color filter layer is formed;

FIG. 4 is a sectional view showing a state in which a color filter layer is formed; and

FIG. 5 is a graph showing transfer efficiencies of solid-state imaging devices of one example of the invention and the comparative example.

### DETAILED DESCRIPTION OF THE EXEMPLARY EMBODIMENTS

Although the invention will be described below with reference to the exemplary embodiment thereof, the following exemplary embodiment and its modification do not restrict the invention.

An exemplary embodiment of the invention has a process to remove, by polish, a charged layer formed in a surface of an organic film after sintered. Due to this, even where static electricity stays on the surface of an insulation film due to repetition of pure-water rinsing and high-speed spin drying on the insulating film upon forming the insulation film, the insulation film can be removed of electricity by removing the charged layer. For a solid-state imaging device, transfer efficiency can be prevented from deteriorating upon transferring a charge after taking an image.

According to the invention, a method for manufacturing a solid-state imaging device is provided, in which charge transfer efficiency is to be prevented from lowering resulting from the electric charge on a surface of an organic insulation material of the color filter, etc. thereof.

Based on the drawings, an exemplary embodiment of the present invention will be explained in detail below.

The present embodiment explains on an example of a manufacturing process of a solid-state imaging device. However, the invention is not limited to that but applicable to a forming process of insulation and organic films above a substrate. In the embodiment, a color filter refers to a filter arrangement with a plurality of color filter elements on the common plane.

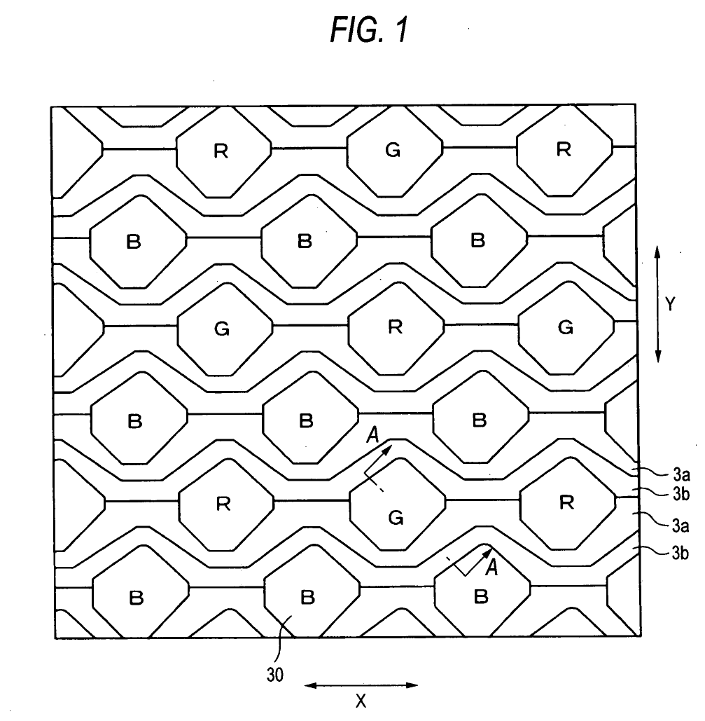

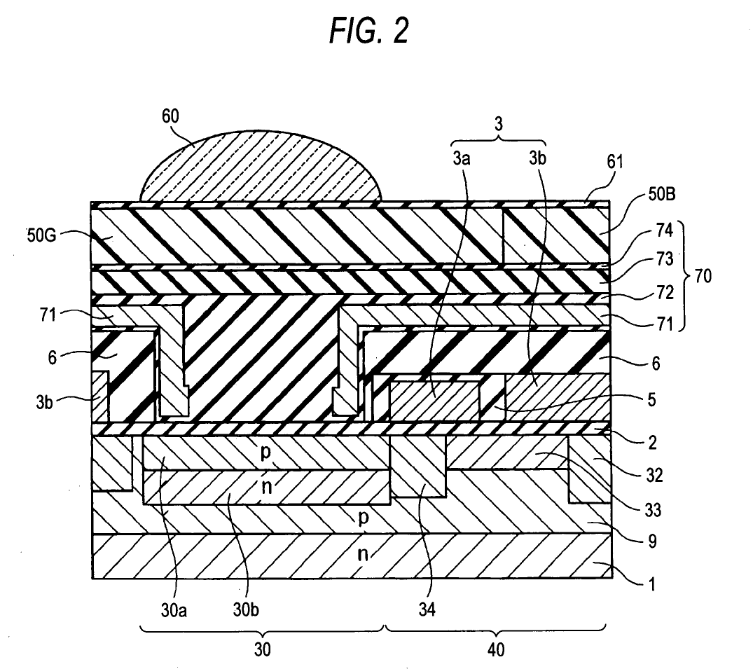

FIG. 1 is a plan view of a solid-state imaging device for explaining the embodiment of the invention. FIG. 2 is a sectional view taken on line A-A.

A solid-state imaging device shown in FIGS. 1 and 2 has a silicon substrate (hereinafter, referred to as a substrate) 1, a photoelectric converter formed on the substrate 1, and a charge transferer where to transfer charges generated at the photoelectric converter. Specifically, a plurality of photodiodes 30, i.e. photoelectric converters, are arranged in a surface of an n-type substrate 1. A plurality of charge transfers 40 are arranged to transfer signal charges, generated at the photodiodes 30, in a column direction (in a Y direction in FIG. 1). The charge transfers 40 are formed each extending zigzag through between the columns of the photodiodes 30. The photodiodes 30 are in so-called a honeycomb arrangement that the photodiode 30 on the odd-numbered column are deviated approximately a half pitch of the photodiode 30 arranged in the column direction relative to the photodiode on the even-numbered column.

As shown in FIG. 2, a red filter 50R (not shown), a green filter 50G and a blue filter 50B are arranged in a pattern on the planarization film 74, in positions correspondingly to and over the photodiodes 30. In FIG. 1, reference characters (R, G, B) are attached to represent the colors of the filters respectively formed over the photodiodes 30. A color filter layer is made up by the color filters 50R, 50G, 50B.

The charge transfer 40 includes a plurality of charge transfer channels 33 formed in the column direction in the surface of the substrate 1 correspondingly to the columns of photodiodes, a charge transfer electrode 3 (first electrode 3a, second electrode 3b) formed in a layer above the charge transfer channels 33, and charge read-out regions 34 for reading charges, generated at the photodiodes 30, onto the charge transfer channel 33. The charge transfer electrode 3 is made in a zigzag form extending wholly in the row direction (in the X direction in FIG. 2) through between the rows of photodiodes 30 arranged in the row direction. The charge transfer electrode 3 is not limited to so called a single-level electrode structure, i.e. electrodes are arranged in a single level as in the embodiment, but may be in so-called a two-level electrode structure, i.e. first and second electrodes 3a, 3b are laid in two levels.

As shown in FIG. 2, a p-well layer 9 is formed in the surface of the substrate 1, a p region 30a is formed in a surface of the p-well layer 9, and an n region 30b is formed underneath the p region 30a. The p region 30a and the n region 30b constitute a photodiode 30. Signal charges generated at the photodiode 30 are stored in the n region 30b.

The charge transfer channel 33 is formed as an n region on the right side of the p region with a somewhat spacing. The charge read-out region 34 is formed in the p-well layer 9 at between the n region 30b and the charge transfer channel 33.

A gate insulation film 2 is formed on the surface of the substrate 1. First and second electrodes 3a, 3b are formed above the charge read-out region 34 and charge transfer channel 33 through the gate insulation film 2. The first electrode 3a and the second electrode 3b are insulated from each other by an inter-electrode insulation film 5. On the right side of the vertical transfer channel 33, a channel stop 32 is provided by a p+ region, thus providing an isolation of from the adjacent photodiode 30.

On the charge transfer electrode 3, a silicon oxide film 6 is formed, on which an intermediate layer 70 is further formed. Of the intermediate layer 70, reference numeral 71 is a light-shielding film, 72 is an insulation film of BPSG (borophospho silicate glass), 73 is an insulation film (passivation film) of P-SiN, and 74 is a planarization film of transparent resin or the like. The light-shielding film 71 is provided entirely except for the opening areas for the photodiodes 30. A color filter and a microlens 60 are provided on the intermediate layer 70. Between the color filter and the microlens 60, a planarization film 61 is formed of insulating transparent resin or the like. In the solid-state image device of this embodiment, the insulation film 72 of BPSG, the insulation film (passivation film) 73 of P-SiN and the planarization film 74 of transparent resin, etc. are formed.

The solid-state imaging device, in the embodiment, is structured to store the signal charge generated at the photodiode 30 in the n region 30, to transfer the stored signal charge in the column direction through the charge transfer channel 33, to transfer the transferred signal charge in the row direction through a not-shown charge transfer line (HCCD), and to output a color signal through the amplifier in accordance with the transferred signal charge. The substrate 1 is demarcated with a solid-state imager area where formed is the foregoing solid-state imaging device (photoelectric converters, charge transferrers, HCCDs and amplifiers) is formed and a peripheral circuit area where formed is a peripheral circuit (pads, etc.) for the solid-state imaging device.

Referring to FIGS. 1 and 2, explanation is now made on the procedure for manufacturing a solid-state imager of the embodiment.

After forming photoelectric converters 30 and charge transferers 40, a gate insulation film 2 is formed in the surface of the substrate 1. On the gate insulation film 2, a conductive material for a first electrode 3a is deposited. By exposing the conductive material through a mask of the resist patterned by photolithography, a first electrode 3a is formed.

An inter-electrode insulation film 5 is formed to a thickness by oxidation in a manner covering the first electrode 3a at its top and side surfaces. Then, a conductive material for a second electrode 3b is deposited on the gate insulation film 2. By performing a chemical mechanical polishing (CMP) process, formed is a charge transfer electrode 3 in a single-level structure having first and second electrodes 3a, 3b.

After forming a silicon oxide film 6 in a manner covering the charge transfer electrode, a shade material is formed on the silicon oxide film 6 by CVD or PVD and etched to a pattern, thereby forming a light-shielding film 71.

After depositing a CVD oxide film, a BPSG insulation film 72 is processed at elevated temperature to obtain a desired form.

After forming a contact hole in the peripheral circuit, not shown, for the solid-state image device, a metal material is formed in the contact hole. By patterning the metal material to a form, a bonding pad is formed. Then, a P-SiN film 73 is formed by a plasma CVD technique. Etching is made on the silicon nitride film, to remove unwanted portions thereof, e.g. in areas at above the bonding pads.

Then, thermal processing (sintering) is conducted in an inert-gas atmosphere containing H₂.

A visible-light transmissive material is applied to on the P-SiN film 73 by a spin-coat or scan-coat technique, in order for planarization preparatory for forming a color filter layer. By making the upper surface planar by CMP or the like, a planarization film 74 is formed. On this occasion, charges may be removed from the organic film simultaneously with the planarization.

Then, a color filter layer is formed on the planarization film 74. Of the color filters 50R, 50G, 50B constituting the color filter layer, the color filter having the lowest polish rate is taken as a polish stopper layer. At first, the color filter (assumed the color filter 50B in this embodiment) material for a polish stopper layer is applied under a condition to a film thickness and patterned by exposure to radiation with a patterned mask formed by photolithography. Then, the other two color filter are also formed by patterning, in order, by the similar processes.

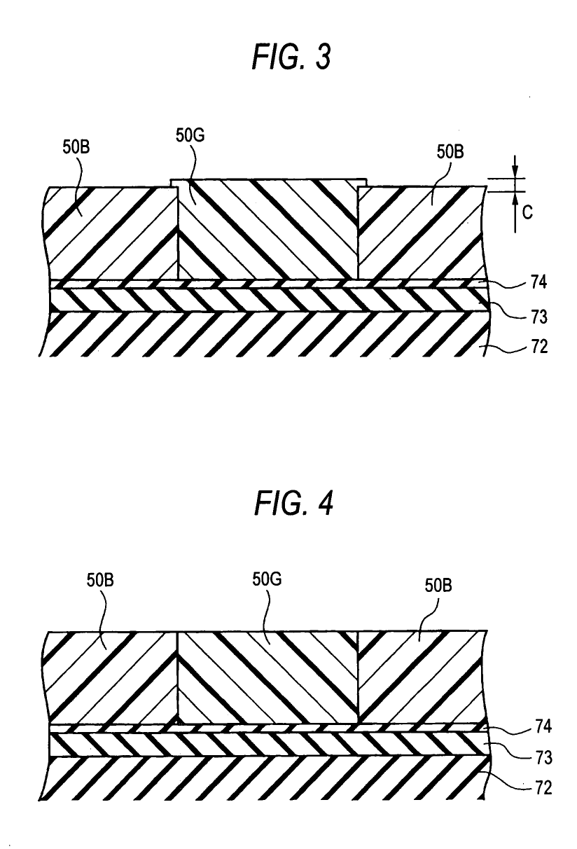

FIGS. 3 and 4 show a state the color filter layer is formed. There is a possibility that static electricity be present on the surface of the color filter layer, resulting from the pure-water rinse or high-speed spin drying repeatedly done in forming the insulation films formed in the lower levels. As shown in FIG. 3, in the invention, the charged region in the surface of the color filter layer is assumed as a charged layer C.

Then, the charged layer C is removed away by polishing. The technique for removing the charged layer C can use CMP, for example. By removing the charged layer C by CMP, surface planarization is to be done simultaneously with the removal of electricity out of the color filter layer (see FIG. 4).

In the embodiment, by taking the color filter 50B as a polish stopper layer, CMP was conducted to remove electricity out of and making planar the surface of the color filter layer. The polishing is stopped if the force required to polish the polish stopper layer exceeds a specific value. In conducting CMP, polish is preferably done by abrasive-free polishing with using a conductive solution added with a surface-active agent or the equivalent hydrophilic surface-treatment agent. In the abrasive-free polishing, particles having a size of 200 nm or more is preferably not used in the conductive solution. By the contact of the color filter layer surface with the conductive solution, the color filter layer surface can be removed of electricity positively. This can suppress the noise resulting from unwanted charge, when taking an image. In addition, it can keep the surface hydrophilic, avoid grinding chips from being put on again, and prevent the pixels from being made defective due to clogging at the pixel region.

By taking the color filter having the lowest polish rate out of the color filters 50R, 50G, 50B structuring the color filter layer, polish can be positively terminated at the target film thickness.

After forming the color filter layer, slurry and contaminations are removed out of the surface of the color filter layer by a cleaning liquid, followed by being dried by blowing ion-balanced air together with heating with a hot plate.

Then, a visible-light transmissive material is applied at a film thickness of 0.5 to 1.0 μm, as a buffer layer for forming a microlens 60. By etching or melt technique, a microlens 60 is formed.

An exemplary embodiment of the invention has a process to remove, by polish, the charged layer C formed in the surface of the color filter layer after sintered. Due to this, even where static electricity is present on the surface of the insulation film due to the repetition of pure-water rinse and high-sped spin drying on the film upon forming the insulation films lower in level than the color filter layer, the color filter can be removed of electricity by removing the charged layer C. For the solid-state imaging device, it can prevent from deteriorating the efficiency of charge transfer after an image is taken.

From now on, an example of the invention is explained.

A solid-state imaging device, in this example, was processed by CMP to remove the charged layer out of the surface of the color filter layer thereof, by use of the manufacturing method applied for the embodiment. As a comparative example, a solid-state imaging device was prepared which was fabricated without removing the charged layer out of the surface of the color filter layer thereof. Using those solid-state imaging devices, imaging was done under the same condition, to measure the respective charge transfer efficiencies. The transfer efficiencies were measured with a CCD evaluation tester. Under the condition with a constant amount of light, the charge amount in a distance relationship to the amplifier was compared as to the charge, of from the VCCDs, under transfer through the HCCD.

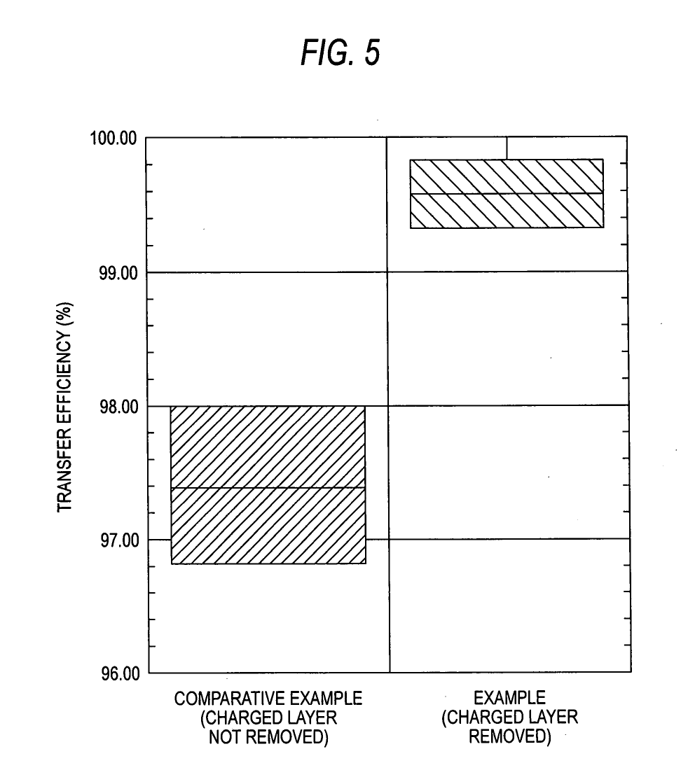

As shown in FIG. 5, it can be confirmed that the solid-state imaging device of the comparative example had a transfer efficiency of approximately 97 to 98% whereas the solid-state imaging device of the present example had an improved transfer efficiency of 99.4 to 99.8%.

While the invention has been described with reference to the exemplary embodiments, the technical scope of the invention is not restricted to the description of the exemplary embodiments. It is apparent to the skilled in the art that various changes or improvements can be made. It is apparent from the description of claims that the changed or improved configurations can also be included in the technical scope of the invention.

This application claims foreign priority from Japanese Patent Application No. 2006-117940, filed Apr. 21, 2006, the entire disclosure of which is herein incorporated by reference.

What is claimed is:

1. A method for forming an organic film, comprising:
forming an insulation film above a substrate;
performing a sintering before or after the forming of the insulation film;
forming an organic film on the insulation film; and
removing, by polish, a charged layer in a surface of the organic film.

2. A method for manufacturing a solid-state imaging device, comprising:
forming an insulation film above a substrate;
sintering the insulation film;
forming a color filter layer on the insulation film; and
removing, by polish, a charged layer in a surface of the color filter layer.

3. The method according to claim 2, wherein the charged layer is polished by a chemical mechanical polishing process.

4. The method according to claim 2, wherein the polish is performed by abrasive-free polishing with a conductive solution comprising a surface-active agent or a hydrophilic surface-treatment agent equivalent thereto.

5. The method according to claim 4, wherein the color filter layer has a plurality of color filters, and a layer lowest in polish rate of the plurality of color filters is taken as a polish stopper layer.
